(19) United States
(12) Patent Application Publication
(10) Pub. No.: US 2006/0085424 A1
(43) Pub. Date: Apr. 20, 2006

(54) Web page downloading device with distributed data flows and method thereof

(75) Inventor: Chung-Chih Tung, Taipei (TW)

Correspondence Address: Eric D. Cohen;Welsh & Katz, Ltd., 22nd Floor, 120 South Riverside Plaza, Chicago, IL, 60606, US

(73) Assignee: Mitac Technology Corp., Hsin-Chu Hsien (TW)

(21) Appl. No.: 10/965,242

(22) Filed: Oct. 14, 2004

(51) Int. Cl. G06F 17/30

(52) U.S. Cl. 707/10

(57) ABSTRACT

This specification discloses a web page downloading device with distributed data flows and the method thereof. When a browser sends out a web page request signal, the server end first uses a data flow monitoring module to detect the data flows of several transmission lines. A data flow distributing module then divides the multimedia contents, such as pictures, videos, executables, compressed files, etc, in the web page into several transmission packets. These packets are transmitted via the all the transmission lines.

### BACKGROUND OF THE INVENTION

1. Field of Invention

The invention relates to a web page downloading device that distributes data flows for transmitting web page contents and the method thereof.

2. Related Art

The modern structure of transmitting data among browsers 10 and servers 20 on the Internet is demonstrated in FIG. 1. The web page contents transmission, including the multimedia data (e.g. pictures, text, videos, executables, etc), is done using a single transmission line of the same Internet protocol (IP) address on a web server. The bandwidth of the transmission line is the maximum data that can be carried by it. For example, if the bandwidth of the transmission line used by the server 20 is 256K, it means that the maximum data that can be transmitted by the transmission line is 256K per second.

However, as more contents are included in web pages, a higher transmission rate is required. Therefore, users often have to wait for a long time when using a small-bandwidth transmission line to transmit web page data.

To solve the problem of insufficient bandwidth, a simplest and common method at the server end is to replace the original transmission line by another one with a larger bandwidth. This can increase the data transmission rate and reduce the user's waiting time. The original transmission line is abandoned or used for other functions. Nonetheless, the price of a transmission line is not proportional to its speed, but to a higher power of the speed. For example, the price of a 256K transmission line is not twice that of a 128K transmission line. It is even higher. Therefore, the cost of two 128K transmission lines shall be less than one 256K transmission line.

Thus, the cost for expanding the bandwidth is a constraint for small companies. Abandoning the old transmission lines is also a waste of resources.

### SUMMARY OF THE INVENTION

In view of the foregoing, an objective of the invention is to provide a web page downloading device with distributed data flows and the method thereof. Using several transmission lines connected to the server, non-text files (multimedia contents) in a web page, such as pictures, videos, executables, compressed files, and so on, are distributed to all the transmission lines, followed by the transmission of web page contents. This is because the files with larger sizes during the web page transmission are non-text ones.

Using the disclosed web page downloading device and method, several transmission lines with smaller bandwidths are connected to the server. When a browser sends out the request for web page contents, the data flow monitoring module at the server end first detects the data transmission statuses of the transmission lines to find out which ones are busy and which are not.

The non-text files in the web page are divided by the data flow distributing module into several transmission packets. Finally, these transmission lines simultaneously send the transmission packets out.

The invention combines transmission lines with smaller bandwidths in parallel. Data in a web page for output are distributed to all the transmission lines. Aside from keeping original transmission lines with smaller bandwidths, the invention effectively achieves the functions of a large-bandwidth transmission line or even better. This is because using several transmission lines to transmit web page data at the same time is less likely to encounter network jams.

For the same amount of data flow, the cost of installing several small-bandwidth lines is much cheaper than that of one large-bandwidth line. Thus, the invention can reduce the user's cost.

### BRIEF DESCRIPTION OF THE DRAWINGS

The invention will become more fully understood from the detailed description given hereinbelow illustration only, and thus are not limitative of the present invention, and wherein:

FIG. 1 shows a system structure when a browser and a server transmit data on the Internet in the prior art;

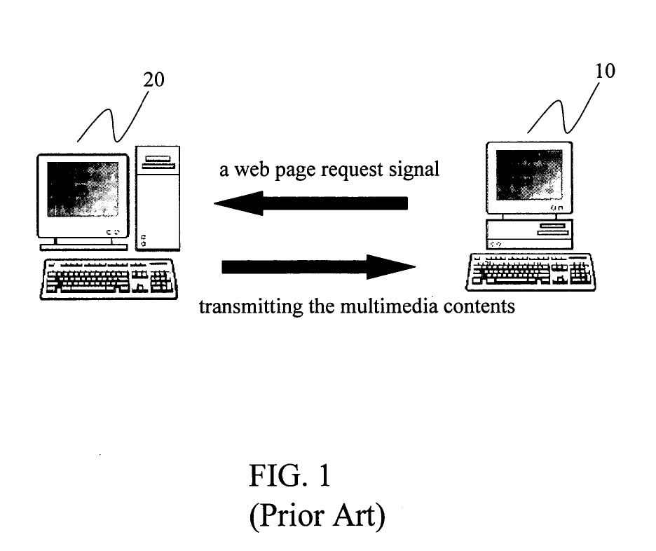

FIG. 2 shows a system structure when a browser and a server transmit data on the Internet according to the invention;

FIG. 3 shows the structure of the disclosed web page downloading device; and

FIG. 4 is a flowchart of the disclosed web page downloading method.

### DETAILED DESCRIPTION OF THE INVENTION

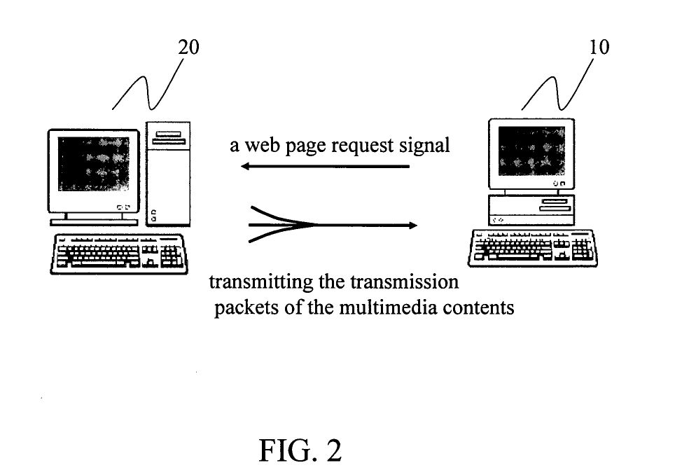

The structure of the disclosed web page downloading device with distributed data flows is shown in FIG. 2. When the server 20 receives a web page request signal sent out from a browser 10 at a client end, the server 20 uses the disclosed web page downloading device with distributed data flows to transmit web page contents to the browser 10 via several small-bandwidth transmission lines connected to the server 20.

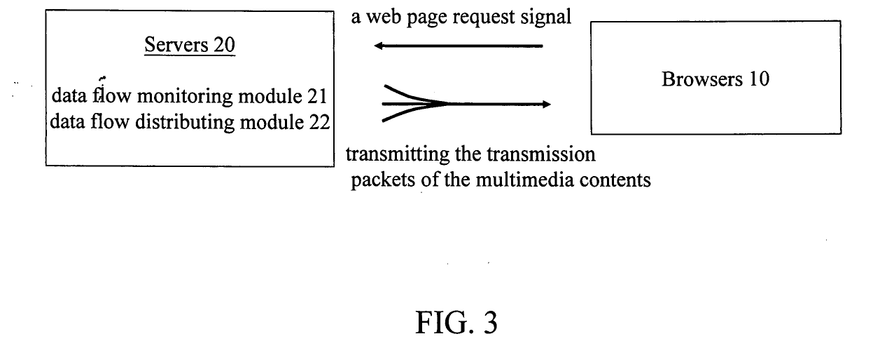

As shown in FIG. 3, the web page downloading device contains two major modules: the data flow monitoring module 21 and the data flow distributing module 22. The data flow monitoring module 21 is used to monitor the uses of all the transmission lines, determining which ones have larger data flows and which ones have smaller data flows.

The data flow distributing module 22 is used to divide web page contents into transmission packets of different sizes according to the statuses of the transmission lines detected by the data flow monitoring module 21. The file sizes of the transmission packets are determined according to the principle that the total data transmitted by the transmission lines are roughly the same.

The time and speed of transmitting web page contents using the disclosed device is the same as or better than using one transmission line with a larger bandwidth. However, the cost of installing several small-bandwidth lines is much cheaper than that of one large-bandwidth line. Moreover, the original transmission lines are re-used without waste.

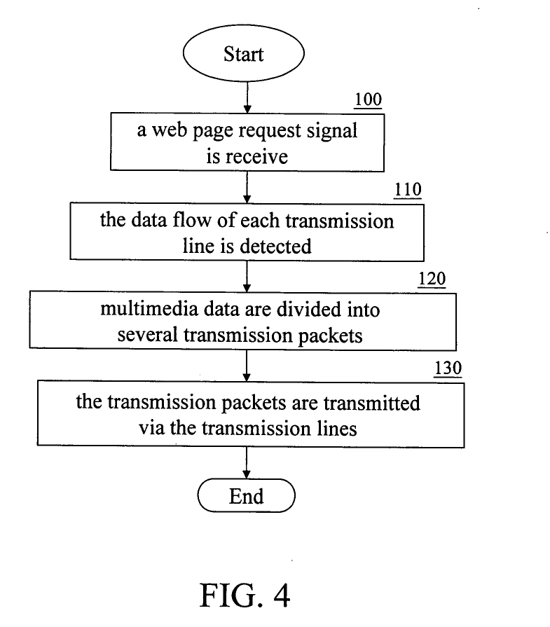

The flowchart of the web page downloading method with distributed data flows is shown in FIG. 4. Please also refer to FIG. 3 for the elements mentioned in the following description.

First, a web page request signal is received (step 100). The browser 10 at the client end sends a web page request signal to the connected server 20. Once the server 20 receives this signal, it knows what to be transmitted to the client browser 10.

Afterwards, the data flow of each transmission line is detected (step 110). The data flow monitoring module 21 inside the server 20 immediately detects the data flow of each transmission line. Once the server 20 receives the web page request signal, it knows from the data obtained by the data flow monitoring module 21 which transmission lines have larger data flows and which one have smaller data flows at the instant.

Multimedia data are divided into several transmission packets (step 120). Since most of the time multimedia files (such as the pictures, videos, executables, compressed files, etc presented in the web page) have larger sizes in a web page, the data flow distributing module 22 in the server 20 divides them into several transmission packets of different sizes according to the detect data flows of the transmission lines. The file sizes of the transmission packets are determined according to the principle that the total data transmitted by the transmission lines are roughly the same.

Finally, the transmission packets are transmitted via the transmission lines (step 130). Once the multimedia contents are divided into several transmission packets, they along with text files are sent via the transmission lines to the browser. This completes the web page downloading method with distributed data flows.

The program for transmitting picture files in a web page from the server 20 in the HTML language is as follows:

<html>
<head>
<meta http-equiv=“Content-Language” content=“en-us”>
<meta http-equiv=“Content-Type” content=“text/html; charset=big5”>
<meta name=“GENERATOR” content=“Microsoft FrontPage 4.0”>
<meta name=“ProgId” content=“FrontPage.Editor.Document”>
<title>This is a test HTML</title>
</head>
<body>
<p>This is a test HTML.</p>
<p><img border=“0” src=“subhed_l.gif” width=“62” height=“45”></p>
<p><img border=“0” src=“subhed_m.gif” width=“215”
height=“23”></p>
<p><img border=“0” src=“subhed_r.gif” width=“53” height=“28”></p>

Suppose the server 20 is installed with three transmission lines. According to the disclosed method, the IP addresses of these transmission lines are, respectively, 192.1.1.1, 192.1.1.2, and 192.1.1.3. Suppose the client sends out a web page request signal to the 192.1.1.1 transmission line, and the data flow monitoring module 21 detects that the 192.1.1.1 transmission line has a busy data flow. The system automatically modifies the HTML file to the following:

<html>
<head>
<meta http-equiv=“Content-Language” content=“en-us”>
<meta http-equiv=“Content-Type” content=“text/html; charset=big5”>
<meta name=“GENERATOR” content=“Microsoft FrontPage 4.0”>
<meta name=“ProgId” content=“FrontPage.Editor.Document”>
<title>This is a test HTML</title>
</head>
<body>
<p>This is a test HTML.</p>
<p><img border=“0” src=“192.1.1.2\subhed_l.gif” width=“62”
height=“45”></p>
<p><img border=“0” src=“192.1.1.3\subhed_m.gif” width=“215”
height=“23”></p>
<p><img border=“0” src=“192.1.1.2\subhed_r.gif” width=“53”
height=“28”></p>
</body>
</html>

From the boldface part of the modified program, one sees that the picture files that occupy larger bandwidths are distributed to the other transmission lines because the 192.1.1.1 transmission line is detected to be busy. Thus, the invention achieves the goal of distributing data into smaller bandwidths.

Certain variations would be apparent to those skilled in the art, which variations are considered within the spirit and scope of the claimed invention.

What is claimed is:

1. A web page downloading device with distributed data flows for transmitting web page data via a plurality of transmission lines after receiving a web page request signal, having characteristics in: the web page downloading device comprising a data flow monitoring module and a data flow distributing module, and wherein the data flow monitoring module detects the data flows of the transmission lines before transmitting the web page data, and the data flow distributing module distributes multimedia contents of the web page into the transmission lines for data transmissions.

2. The web page downloading device with distributed data flows of claim 1, wherein the data flow distributing module divides the multimedia contents into a plurality of transmission packets according to the data flows of the transmission lines detected by the data flow monitoring module for data transmissions.

3. The web page downloading device with distributed data flows of claim 1, wherein the multimedia contents are picture files.

4. The web page downloading device with distributed data flows of claim 1, wherein the multimedia contents are video files.

5. The web page downloading device with distributed data flows of claim 1, wherein the multimedia contents are executable files.

6. The web page downloading device with distributed data flows of claim 1, wherein the multimedia contents are compressed files.

7. A web page downloading method with distributed data flows for transmitting web page data via a plurality of transmission lines after receiving a web page request signal, the web page downloading method comprising the steps of:
(1) receiving a web page request signal;
(2) detecting data flows of the transmission lines;
(3) dividing multimedia contents into a plurality of transmission packets; and
(4) transmitting the transmission packets via the transmission lines.

8. The web page downloading method with distributed data flows of claim 7, wherein the step of dividing multimedia contents into a plurality of transmission packets is performed according to the data flows of the transmission lines detected.

9. The web page downloading method with distributed data flows of claim 7, wherein the multimedia contents are picture files.

10. The web page downloading method with distributed data flows of claim 7, wherein the multimedia contents are video files.

11. The web page downloading method with distributed data flows of claim 7, wherein the multimedia contents are executable files.

12. The web page downloading method with distributed data flows of claim 7, wherein the multimedia contents are compressed files.
